(19) United States
(12) Patent Application Publication
(10) Pub. No.: US 2008/0033607 A1
(43) Pub. Date: Feb. 7, 2008

(54) MONITORING SYSTEM FOR AIRCRAFT LANDING SYSTEM

(76) Inventors: Bob Zeliff, Vergennes, VT (US); Chuang-Chia Lin, Burnsville, MN (US); Andy Walsh, Troy, OH (US); Neil Harris, Brooklyn, OH (US); Adnan Cepic, Oakville (CA)

Correspondence Address: DON W. BULSON (GOODRICH);RENNER, OTTO, BOISSELLE & SKLAR, LLP, 1621 EUCLID AVENUE, 19TH FLOOR, CLEVELAND, OH, 44115, US

(21) Appl. No.: 11/756,891

(22) Filed: Jun. 1, 2007

Related U.S. Application Data
(60) Provisional application No. 60/803,637, filed on Jun. 1, 2006.

(51) Int. Cl. G01M 17/007; G01M 17/013; G01M 17/02; G06F 19/00

(52) U.S. Cl. 701/29

(57) ABSTRACT

A monitoring system for a landing gear system comprising a plurality of sensors for monitoring respective parameters of the aircraft landing system, and a monitor which receives the outputs of the sensors.

The invention herein described relates generally to aircraft landing systems and more particularly to monitoring systems for aircraft landing systems.

### SUMMARY OF THE INVENTION

The present invention provides a monitoring system for an aircraft landing system. A monitoring system and associated method according to the invention is characterized by a plurality of sensors for monitoring respective parameters of the aircraft landing system including one or more of the following: tire pressure; strut oil level; strut pressure; strut position; strut temperature; brake wear measurement; wheel temperature; brake temperature; wheel bearing temperature; actuator temperature; brake vibration, wheel shimmy and other vibrations; component strain and/or stress; brake torque; corrosion; weight on wheels; landing gear states; component temperature and/or loading in general; ambient conditions such as temperature and humidity; etc.

The outputs of the sensors are communicated, preferably wirelessly, to a monitor wherein the outputs are processed to provide diagnostic information that can displayed, stored and/or further processed to provide operational information regarding the aircraft landing system, such as hard landing indication, high ground load indication, brake usage, landing cycle counting, fatigue, etc.

The system may be integrated into an overall aircraft health unit monitoring system (HUMS).

Provision may also be made for wireless control of the landing system and/or braking system.

The invention may be implemented as a ground-based passive sensing system and particularly one where the various sensors are interrogated when the aircraft is on the ground. Such a system may avoid communication during landing and/or taxiing to avoid communication bandwidth issues.

As above indicated, one or more of the sensors may communicate wirelessly with the monitor for transmission of sensor data from the sensors to the monitor and/or for communication of data from the monitor. The sensors may also be powered wirelessly (such as through inductive coupling), by battery and/or by hard wired connection to a source of power. The sensors may be RFID devices mounted on the landing gear at strategic locations for sensing a prescribed condition or state of the landing gear or component thereof. The RFID devices communicate wirelessly with an RFID interrogator device that can be mounted at a strategic location which need not necessarily be on the landing gear, such as at a location in the wheel well of the aircraft. Other wireless sensors that may be used are SAW sensors.

The sensors may be configured to store data for later transmission to the monitor. For example, one or more sensors may be used to provide data from which landing loads on the landing gear and/or components thereof can be calculated. The sensors may later be interrogated, such as when the aircraft is stationary, for acquisition of such data by the monitor that may further process the data and/or transmit the data or processed data to a remote location, such as the cockpit of the aircraft, aircraft system diagnostics memory, and/or an off-aircraft location.

The monitor may have a processor, such as one or more suitably programmed microprocessors, for controlling the retrieving and/or transmission of data, and/or for processing data from the sensors. The monitor may be provided with memory for storage of sensor data and/or processed data for later retrieval and/or transmission to other components on and/or off the aircraft. The monitor may be contained within a single unit and/or the functions thereof may be distributed among a plurality of units, as may be desired.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

### BRIEF DESCRIPTION OF THE DRAWINGS

FIG. 1 is a schematic elevation view of a simplified landing gear assembly incorporating a monitoring system in accordance with the present invention.

### DETAILED DESCRIPTION

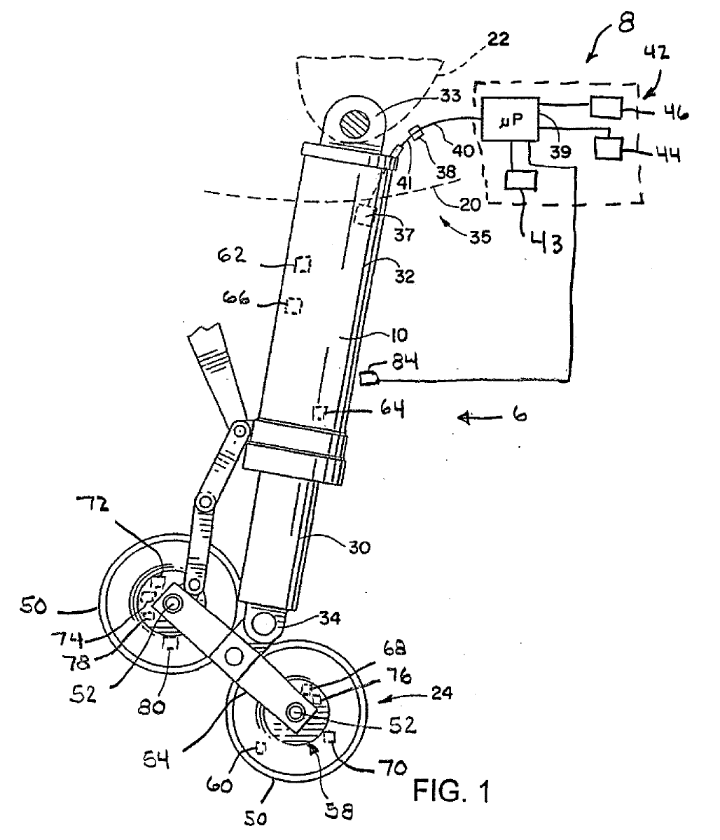

FIG. 1 shows an exemplary aircraft landing system 6 and associated monitoring system 8. The landing system 6 includes a shock strut 10, shown mounted at an upper end to an aircraft structure 20 by an attachment member 22. A wheel assembly 24 is attached to a lower end of the shock strut 10. The aircraft structure 20, attachment member 22, and wheel assembly 24 are shown in simple or outline form, while other structures such as locking mechanisms and retracting mechanisms are not shown in FIG. 1. Various arrangements of such structures are known in the art and are not critical to the description or understanding of the invention.

The shock strut 10 includes a piston 30 and a cylinder 32 which may be cylindrical as is customary, or some other shape if desired. The cylinder and piston respectively have one or more mounting tabs (eyes) 33 and 34 for attachment to the aircraft structure 20 and the wheel assembly 24. The piston 30 communicates forces to and from the wheel assembly 24. The cylinder 32 receives the piston 30 in a manner that permits relative telescoping movement between the cylinder 32 and the piston 30 to absorb and dampen shock forces from being transmitted to the aircraft structure 20.

The monitoring system 8 includes one or more sensors for monitoring respective parameters of the aircraft landing system. One such sensor is a sensor assembly or detector 35 that is provided for sensing or detecting a condition of a level of a liquid contained within the strut 10 (as in the manner hereinafter described) and outputting a signal related to the liquid level. In the illustrated embodiment, the detector 35 includes a probe assembly 37 extending into the strut and a transmitter/receiver or sensor unit 38 located outside the strut for transmitting/receiving signals to/from the probe assembly. The sensor unit 38 communicates the signal from the probe assembly 37 to a monitor 42 including a computer, processor or other logic device 39 for analyzing the signal and for determining a condition of the amount of liquid in the strut 10.

The monitor 42 may include a memory 43 and software associated therewith to carry out monitoring operations, and may be located near the strut 10, may be remote from the strut or may be a combination with some processing and/or data storage occurring near the strut and other processing and/or data storage occurring at another location. The monitor also may include and/or be coupled to a display 44, which may be on the flight deck or in the wheel well, or may be connected by maintenance personnel as needed. The monitor 39 can communicate with the sensor unit 38 via an electric or optical cable 40, or by other means such as a radio frequency transmitter and receiver, or other device. The monitor may also be equipped with data transmission means 46 for communicating with remote system on or off the aircraft.

For further details of an exemplary sensor unit 38 and operation thereof, reference may be had to U.S. Published Application No. 2004/0129834, which is hereby incorporated herein by reference in its entirety.

The monitoring system 8 may comprise one or more additional sensors for monitoring respective parameters of the aircraft landing system including one or more of the following: tire pressure; strut pressure; strut position; strut temperature; brake wear measurement; wheel temperature; brake temperature; wheel bearing temperature; actuator temperature; brake vibration, wheel shimmy and other vibrations; component strain and/or stress; brake torque; corrosion; weight on wheels; landing gear states; component temperature and/or loading in general; ambient conditions such as temperature and humidity; etc.

More particularly, the wheel assembly 24 includes one or more wheels 50 mounted to respective axles 52 of a bogie beam 54 by suitable bearings. One or more of the wheels may have associated therewith a brake assembly generally indicated at 58. In the illustrated embodiment, the monitoring system 8 includes a tire pressure sensor 60, a strut pressure sensor 62, a strut position sensor 64, a strut temperature sensor 66 (measuring oil temperature for example), a brake wear measurement sensor 68, a wheel temperature sensor 70, a brake temperature sensor 72, a wheel bearing temperature sensor 74, a brake actuator temperature sensor 76, a brake vibration sensor 78, and a wheel shimmy sensor 80. The outputs of the sensors are communicated, preferably wirelessly, to the monitor 42 wherein the outputs are processed to provide diagnostic information that can displayed, stored and/or further processed to provide operational information regarding the aircraft landing system, such as hard landing indication, high ground load indication, brake usage, landing cycle counting, fatigue, etc.

The monitoring system 8 may be implemented as a ground-based passive sensing system and particularly one where the various sensors are interrogated when the aircraft is on the ground. Such a system may avoid communication during landing and/or taxiing to avoid communication bandwidth issues.

As above indicated, one or more of the sensors may communicate wirelessly with the monitor for transmission of sensor data from the sensors to the monitor and/or for communication of data from the monitor. The sensors may also be powered wirelessly (such as through inductive coupling), by battery and/or by hard wired connection to a source of power. The sensors may be RFID devices mounted on the landing gear at strategic locations for sensing a prescribed condition or state of the landing gear or component thereof. The RFID devices communicate wirelessly with an RFID interrogator device (one indicated at 84) that can be mounted at a strategic location which need not necessarily be on the landing gear, such as at a location in the wheel well of the aircraft. Other wireless sensors that may be used are SAW sensors.

The sensors may be configured to store data for later transmission to the monitor. For example, one or more sensors may be used to provide data from which landing loads on the landing gear and/or components thereof can be calculated. The sensors may later be interrogated, such as when the aircraft is stationary, for acquisition of such data by the monitor that may further process the data and/or transmit the data or processed data to a remote location, such as the cockpit of the aircraft, aircraft system diagnostics memory, and/or an off-aircraft location.

The monitor 8, as above indicated, may have a processor, such as one or more suitably programmed microprocessors, for controlling the retrieving and/or transmission of data, and/or for processing data from the sensors. The monitor may be provided with memory for storage of sensor data and/or processed data for later retrieval and/or transmission to other components on and/or off the aircraft. The monitor may be contained within a single unit and/or the functions thereof may be distributed among a plurality of units, as may be desired.

Although the invention has been shown and described with respect to certain illustrated embodiment, equivalent alterations and modifications will occur to others skilled in the art upon reading and understanding the specification and the annexed drawings. For example, although an embodiment of the invention directed to an aircraft strut is described, a shock absorber provided by the present invention may have other applications other than aeronautical applications. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention.

1. A monitoring system for a landing gear system comprising a plurality of sensors for monitoring respective parameters of the aircraft landing system, and a monitor which receives the outputs of the sensors.

2. A system as set forth in claim 1, wherein at least one of the sensors communicates wirelessly with the monitor.

3. A system as set forth in claim 1, wherein the monitor includes a processor for processing the outputs of the sensors to provide diagnostic information that can displayed, stored and/or further processed to provide operational information regarding the aircraft landing system.

4. A system as set forth in claim 3, wherein the operational information includes one or more of a hard landing indication, high ground load indication, brake usage, landing cycle counting, and fatigue.

5. A system as set forth in claim 1, wherein the sensed parameter include one or more of the following: tire pressure; strut oil level; strut pressure; strut position; strut temperature; brake wear measurement; wheel temperature; brake temperature; wheel bearing temperature; actuator temperature; brake vibration, wheel shimmy and other vibrations; component strain and/or stress; brake torque; corrosion; weight on wheels; landing gear states; component temperature and/or loading in general; ambient conditions such as temperature and humidity.

6. A monitoring method for a landing gear system comprising monitoring a plurality of sensors to sense respective parameters of the aircraft landing system.
